(19) United States
(12) Patent Application Publication
(10) Pub. No.: US 2015/0312871 A1
(43) Pub. Date: Oct. 29, 2015

(54) MOBILE COMMUNICATION SYSTEM AND MOBILE COMMUNICATION METHOD

(71) Applicant: KYOCERA CORPORATION, Kyoto (JP)

(72) Inventor: Fangwei Tong, Machida-shi (JP)

(73) Assignee: KYOCERA CORPORATION, Kyoto (JP)

(21) Appl. No.: 14/441,816

(22) PCT Filed: Nov. 5, 2013
(86) PCT No.: PCT/JP2013/079928

§ 371 Date: May 8, 2015

Related U.S. Application Data
(60) Provisional application No. 61/724,393, filed on Nov. 9, 2012.

(51) Int. Cl. H04W 56/00; H04W 24/10; H04W 28/16

(52) U.S. Cl. CPC H04W 56/0045; H04W 28/16; H04W 24/10

(57) ABSTRACT

A non-anchor radio base station comprises: a non-anchor side measurement unit configured to measure reception quality of an uplink signal received from the radio terminal; and a notification unit configured to notify the anchor radio base station of the reception quality measured by the non-anchor side measurement unit. The anchor radio base station comprises: a transmission unit configured to transmit a control signal for adjusting a timing, at which the radio terminal transmits an uplink signal, to the radio terminal in order to adjust a timing, at which the uplink signal is received from the radio terminal, to a desired timing; and a determination unit configured to determine whether or not to exclude the non-anchor radio base station from the radio base station group on the basis of the reception quality notified from the non-anchor radio base station.

### TECHNICAL FIELD

The present invention relates to a mobile communication system including a plurality of radio base stations, and a mobile communication method used in the mobile communication system.

### BACKGROUND ART

Conventionally, there has been known a mobile communication system including a plurality of radio base stations. For example, as such a mobile communication system, LTE (Long Term Evolution) has been known.

Furthermore, as a process cooperatively performed by the plurality of radio base stations, a handover, a cooperative reception process, a cooperative transmission process and the like are considered. The cooperative reception process and the cooperative transmission process are called CoMP (Coordinated Multi-Point Operation) and the like (See non-patent document 1). For example, in a cooperative reception process in an uplink, selection combining of uplink signals, which are received in the plurality of radio base stations, is performed.

Specifically, the plurality of radio base stations include one anchor radio base station and the other non-anchor radio base stations. The non-anchor radio base stations transmit uplink signals to the anchor radio base station via a backhaul network. The anchor radio base station performs selection combining of an uplink signal transmitted from a radio terminal and the uplink signals received from the non-anchor radio base stations.

### PRIOR ART DOCUMENT

### Non-Patent Document

Non-Patent Document 1: 3GPP technical report “TR 36.819 V11.1.0” December 2011.

### SUMMARY OF THE INVENTION

In such a case, it is preferable to make synchronization between the plurality of radio base stations and the radio terminal. However, in the cooperative reception process in the uplink, since timings, at which the radio terminal transmits an uplink signal to the plurality of radio base stations, are equal to one another, it is not possible to make synchronization between the radio base stations and the radio terminal with respect to each of the plurality of radio base stations.

A mobile communication system according to a first characteristic includes a plurality of radio base stations that communicate with a radio terminal. The plurality of radio base stations constitute a radio base station group including one anchor radio base station and non-anchor radio base stations other than the anchor radio base station. The non-anchor radio base station includes a non-anchor side measurement unit configured to measures reception quality of an uplink signal received from the radio terminal, and a notification unit configured to notifies the anchor radio base station of the reception quality measured by the non-anchor side measurement unit. The anchor radio base station includes a transmission unit configured to transmits a control signal for adjusting a timing, at which the radio terminal transmits the uplink signal, to the radio terminal in order to adjust a timing, at which the uplink signal is received from the radio terminal, to a desired timing, and a determination unit configured to determines whether or not to exclude the non-anchor radio base station from the radio base station group on the basis of the reception quality notified from the non-anchor radio base station.

A mobile communication method according to a second characteristic is used in a mobile communication system including a plurality of radio base stations that communicate with a radio terminal. The plurality of radio base stations constitute a radio base station group including one anchor radio base station and non-anchor radio base stations other than the anchor radio base station. The mobile communication method includes a step A of transmitting, by the anchor radio base station, a control signal for adjusting a timing, at which the radio terminal transmits an uplink signal, to the radio terminal in order to adjust a timing, at which the uplink signal is received from the radio terminal, to a desired timing, a step B of measuring, by the non-anchor radio base station, reception quality of the uplink signal received from the radio terminal, a step C of notifying, by the non-anchor radio base station, the anchor radio base station of the reception quality measured in the step B, and a step D of determining, by the anchor radio base station, whether or not to exclude the non-anchor radio base station from the radio base station group on the basis of the reception quality notified from the non-anchor radio base station.

### BRIEF DESCRIPTION OF THE DRAWINGS

FIG. 1 is a diagram illustrating a mobile communication system 100 according to a first embodiment.

FIG. 2 is a diagram illustrating a radio frame according to the first embodiment.

FIG. 3 is a diagram illustrating a radio resource according to the first embodiment.

FIG. 4 is a diagram illustrating a case where the first embodiment is applied.

FIG. 5 is a diagram illustrating a case where the first embodiment is applied.

FIG. 6 is a diagram illustrating a case where the first embodiment is applied.

FIG. 7 is a block diagram illustrating an anchor radio base station 310A according to the first embodiment.

FIG. 8 is a block diagram illustrating a non-anchor radio base station 310B according to the first embodiment.

FIG. 9 is a sequence diagram illustrating an operation of (a first technique) of a mobile communication system 100 according to the first embodiment.

FIG. 10 is a sequence diagram illustrating an operation of (a second technique) of the mobile communication system 100 according to the first embodiment.

FIG. 11 is a diagram illustrating a method of setting a first threshold value according to a first modification.

FIG. 12 is a diagram illustrating a method of setting the first threshold value according to the first modification.

### DESCRIPTION OF THE EMBODIMENT

Hereinafter, a mobile communication system according to an embodiment of the present invention will be described with reference to the drawings. In addition, in the description of the drawings below, identical or similar symbols are assigned to identical or similar portions.

It will be appreciated that the drawings are schematically shown and the ratio and the like of each dimension are different from the real ones. Accordingly, specific dimensions should be determined in consideration of the explanation below. Of course, among the drawings, the dimensional relationship and the ratio may be different.

### Overview of Embodiment

A mobile communication system according to an embodiment includes a plurality of radio base stations that communicate with a radio terminal. The plurality of radio base stations constitute a radio base station group including one anchor radio base station and non-anchor radio base stations other than the anchor radio base station. The non-anchor radio base station includes a non-anchor side measurement unit configured to measure reception quality of the uplink signal received from the radio terminal, and a notification unit configured to notify the anchor radio base station of the reception quality measured by the non-anchor side measurement unit. The anchor radio base station includes a transmission unit configured to transmit a control signal for adjusting a timing, at which the radio terminal transmits an uplink signal, to the radio terminal in order to adjust a timing, at which the uplink signal is received from the radio terminal, to a desired timing, and a determination unit configured to determine whether or not to exclude the non-anchor radio base station from the radio base station group on the basis of the reception quality notified from the non-anchor radio base station.

In the embodiment, the timing, at which the uplink signal is received from the radio terminal, is adjusted to the desired timing for the anchor radio base station, so that whether or not the non-anchor radio base station is excluded from the radio base station group is determined on the basis of the reception quality notified from the non-anchor radio base station. Consequently, it is possible to appropriately exclude a radio base station (a non-anchor radio base station), which does not contribute to a cooperative reception process in an uplink, from the radio base station group. Moreover, since it is not necessary to transmit an uplink signal from the radio base station (the non-anchor radio base station), which does not contribute to the cooperative reception process in the uplink, to an anchor radio base station via the backhaul network, wasteful consumption of a resource of the backhaul network is suppressed.

### First Embodiment

### Mobile Communication System

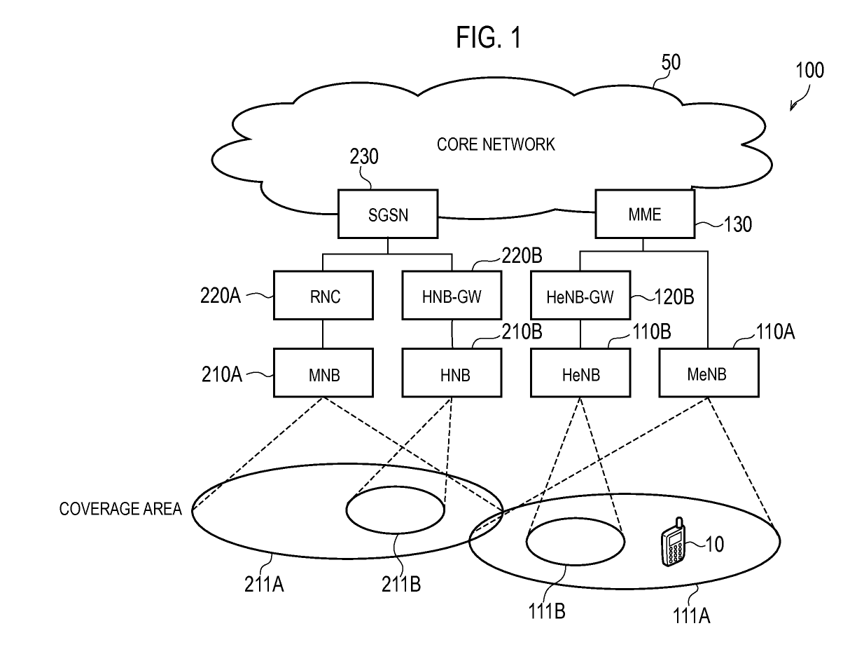

Hereinafter, a mobile communication system according to a first embodiment will be described. FIG. 1 is a diagram illustrating a mobile communication system 100 according to the first embodiment.

As illustrated in FIG. 1, the mobile communication system 100 includes a radio terminal 10 (hereinafter, referred to as UE 10) and a core network 50. Furthermore, the mobile communication system 100 includes a first communication system and a second communication system.

The first communication system is a communication system corresponding to LTE (Long Term Evolution), for example. The first communication system has a base station 110A (hereinafter, referred to as MeNB 110A), a home base station 110B (hereinafter, referred to as HeNB 110B), a home base station gateway 120B (hereinafter, referred to as HeNB-GW 120B), and MME 130, for example.

In addition, a radio access network (E-UTRAN; Evoled Universal Terrestrial Radio Access Network) corresponding to the first communication system is configured by the MeNB 110A, the HeNB 110B, and the HeNB-GW 120B.

The second communication system is a communication system corresponding to UMTS (Universal Mobile Telecommunication System), for example. The second communication system includes a base station 210A (hereinafter, referred to as MNB 210A), a home base station 210B (hereinafter, referred to as HNB 210B), RNC 220A, a home base station gateway 220B (hereinafter, referred to as HNB-GW 220B), and SGSN 230.

In addition, a radio access network (UTRAN; Universal Terrestrial Radio Access Network) corresponding to the second communication system is configured by the MNB 210A, the HNB 210B, the RNC 220A, and the HNB-GW 220B.

The UE 10 is a device (User Equipment) configured to communicate with the second communication system or the first communication system. For example, the UE 10 has a function of performing radio communication with the MeNB 110A and the HeNB 110B. Alternatively, the UE 10 has a function of performing radio communication with the MNB 210A and the HNB 210B.

The MeNB 110A, which manages a general cell 111A, is a device (evolved NodeB) configured to perform radio communication with the UE 10 being present in the general cell 111A.

The HeNB 110B, which manages a specific cell 111B, is a device (Home evolved NodeB) configured to perform radio communication with the UE 10 being present in the specific cell 111B.

The HeNB-GW 120B, which is connected to the HeNB 110B, is a device (Home evolved NodeB Gateway) configured to manage the HeNB 110B.

The MME 130, which is connected to the MeNB 110A, is a device (Mobility Management Entity) configured to manage the mobility of the UE 10 having set up a radio connection with the MeNB 110A. Furthermore, the MME 130, which is connected to the HeNB 110B through the HeNB-GW 120B, is a device configured to manage the mobility of the UE 10 having set up a radio connection with the HeNB 110B.

The MNB 210A, which manages a general cell 211A, is a device (NodeB) configured to perform radio communication with the UE 10 being present in the general cell 211A.

The HNB 210B, which manages a specific cell 211B, is a device (Home NodeB) configured to perform radio communication with the UE 10 being present in the specific cell 211B.

The RNC 220A, which is connected to the MNB 210A, is a device (Radio Network Controller) configured to set up a radio connection (RRC Connection) with the UE 10 being present in the general cell 211A.

The HNB-GW 220B, which is connected to the HNB 210B, is a device (Home NodeB Gateway) configured to set up a radio connection (RRC Connection) with the UE 10 being present in the specific cell 211B.

The SGSN 230 is a device (Serving GPRS Support Node) configured to perform packet switching in a packet switching domain. The SGSN 230 is provided in the core network 50. Although not illustrated in FIG. 1, a device (MSC; Mobile Switching Center) configured to perform circuit switching in a circuit switching domain may be provided in the core network 50.

In addition, it is noted that the general cell and the specific cell are understood as a function of performing radio communication with the UE 10. However, the general cell and the specific cell are also used as a term indicating a coverage area of a cell. Furthermore, cells such as general cells and specific cells are identified by frequencies, spreading codes, time slots and the like used in the cells.

Here, a coverage area of the general cell is wider than a coverage area of the specific cell. The general cell, for example, is a macro cell provided by a communication provider. The specific cell, for example, is a femto cell or a home cell provided by a third party other than the communication provider. The specific cell may be a CSG (Closed Subscriber Group) cell or a pico cell provided by the communication provider.

Hereinafter, the first communication system will be mainly described. The following description may also be applied to the second communication system.

In the first communication system, an OFDMA (Orthogonal Frequency Division Multiple Access) scheme is used as a downlink multiplexing scheme, and an SC-FDMA (Single-Carrier Frequency Division Multiple Access) scheme is used as an uplink multiplexing scheme.

Furthermore, in the first communication system, as an uplink channel, an uplink control channel (PUCCH; Physical Uplink Control Channel), an uplink shared channel (PUSCH; Physical Uplink Shared Channel) and the like exist. Furthermore, as a downlink channel, a downlink control channel (PDCCH; Physical Downlink Control Channel), a downlink shared channel (PDSCH; Physical Downlink Shared Channel) and the like exist.

The uplink control channel is a channel that carries a control signal. The control signal, for example, includes CQI (Channel Quality Indicator), PMI (Precoding Matrix Indicator), RI (Rank Indicator), SR (Scheduling Request), and ACK/NACK.

The CQI is a signal that notifies of a recommended modulation scheme and an encoding rate to be used in downlink transmission. The PMI is a signal that indicates a precoder matrix preferably used for the downlink transmission. The RI is a signal that indicates the number of layers (the number of streams) to be used in the downlink transmission. The SR is a signal that requests the assignment of an uplink radio resource (a resource block which will be described later). The ACK/NACK is a signal that indicates whether or not a signal that is transmitted through a downlink channel (for example, PDSCH) has been able to be received.

The uplink shared channel is a channel that carries a control signal (including the aforementioned control signal) and/or a data signal. For example, the uplink radio resource may be assigned only to the data signal, or may be assigned such that the data signal and the control signal are multiplexed.

The downlink control channel is a channel that carries a control signal. The control signal is, for example, Uplink SI (Scheduling Information), Downlink SI (Scheduling Information), and TPC bit.

The Uplink SI is a signal that indicates the assignment of the uplink radio resource. The Downlink SI is a signal that indicates the assignment of a downlink radio resource. The TPC bit is a signal that indicates increase and decrease in power of a signal that is transmitted through the uplink channel.

The downlink shared channel is a channel that carries the control signal and/or the data signal. For example, the downlink radio resource may be assigned only to the data signal, or may be assigned such that the data signal and the control signal are multiplexed.

In addition, examples of the control signal transmitted through the downlink shared channel include TA (Timing Advance). The TA is information for correcting the timing of transmission between the UE 10 and the MeNB 110A, and is measured by the MeNB 110A on the basis of an uplink signal transmitted from the UE 10. Specifically, TA is an example of a control signal, which adjusts the transmission timing of an uplink signal from the UE 10, in order to adjust the timing, at which the uplink signal is received from the UE 10, to a desired timing.

Furthermore, examples of the control signal that is transmitted through a channel other than the downlink control channel (PDCCH) and the downlink shared channel (PDSCH) include the ACK/NACK. The ACK/NACK is a signal that indicates whether a signal transmitted through the uplink channel (for example, PUSCH) has been able to be received.

In addition, the general cell and the specific cell broadcast broadcast information through a broadcast channel (BCCH; Broadcast Control Channel). The broadcast information, for example, is information such as MIB (Master Information Block) or SIB (System Information Block).

(Radio Frame)

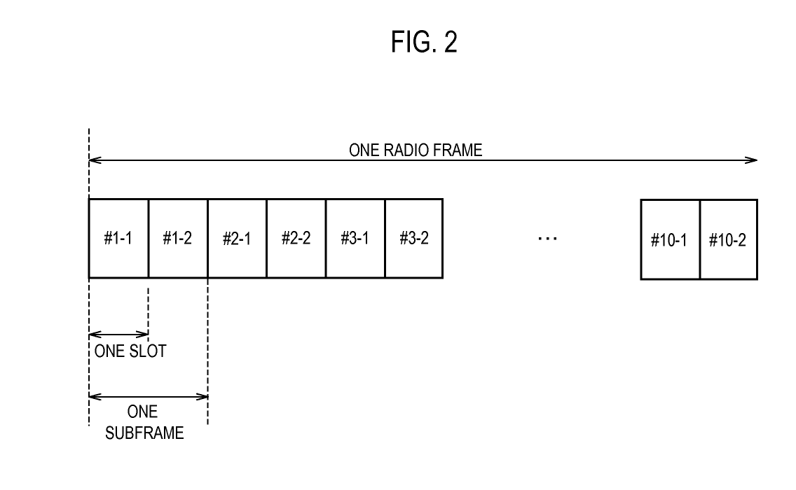

Hereinafter, a radio frame in the first communication system will be described. FIG. 2 is a diagram illustrating the radio frame in the first communication system.

As illustrated in FIG. 2, one radio frame is configured by 10 subframes and one subframe is configured by two slots. One slot has a time length of 0.5 msec, one subframe has a time length of 1 msec, and one radio frame has a time length of 10 msec.

In addition, one slot is configured by a plurality of OFDM symbols (for example, six OFDM symbols or seven OFDM symbols) in a downlink. Similarly, one slot is configured by a plurality of SC-FDMA symbols (for example, six SC-FDMA symbols or seven SC-FDMA symbols) in an uplink.

(Radio Resource)

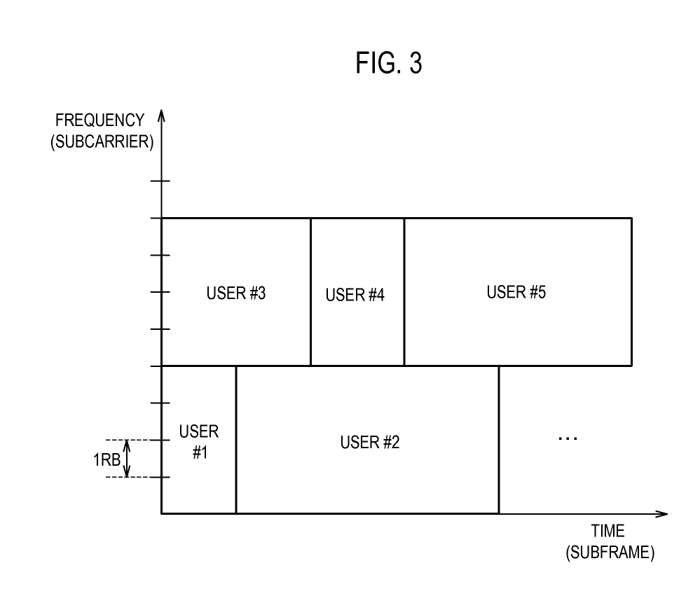

Hereinafter, a radio resource in the first communication system will be described. FIG. 3 is a diagram illustrating the radio resource in the first communication system.

As illustrated in FIG. 3, the radio resource is defined by a frequency axis and a time axis. A frequency is configured by a plurality of subcarriers, and a predetermined number of subcarriers (12 subcarriers) are collectively called a resource block (RB). A time has a unit, such as the OFDM symbol (or the SC-FDMA symbol), the slot, the subframe, and the radio frame, as described above.

Here, the radio resource is assignable to each one resource block. Furthermore, on the frequency axis and the time axis, it is possible to divide and assign the radio resources to a plurality of users (for example, a user #1 to a user #5).

Further, the radio resource is assigned by the MeNB 110A (or the HeNB 110B). The MeNB 110A assigns the radio resources to each UE 10 on the basis of the CQI, the PMI, the RI and the like.

(Application Scene)

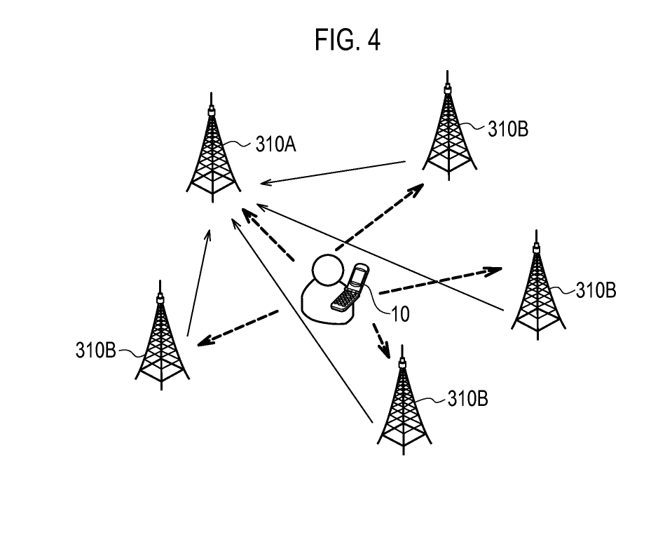

Hereinafter, a scene where the first embodiment is applied will be described. FIG. 4 is a diagram for explaining a scene where the first embodiment is applied. FIG. 4 illustrates the case in which one anchor radio base station 310A and a plurality of non-anchor radio base stations 310B are provided as radio base stations. The anchor radio base station 310A and the non-anchor radio base stations 310B constitute a radio base station group (a CoMP set) configured to receive uplink signals transmitted from the UE 10 in cooperation with each other.

As illustrated in FIG. 4, the UE 10 transmits the uplink signals to the anchor radio base station 310A and the non-anchor radio base stations 310B. It is noted that the uplink signals transmitted from the UE 10 are coded. For example, the uplink signals transmitted from the UE 10, for example, are transmitted through the aforementioned uplink shared channel (PUSCH).

Furthermore, the non-anchor radio base stations 310B transmit uplink signals to the anchor radio base station 310A via the backhaul network. The anchor radio base station 310A performs selection combining of the uplink signal transmitted from the UE 10 and the uplink signals received from the non-anchor radio base stations 310B.

The backhaul network may be an X2 interface for directly connecting radio base stations to each other, or an S1 interface for connecting the radio base stations to each other through an upper node (for example, the MME 130).

It is sufficient if the anchor radio base station 310A and the non-anchor radio base stations 310B are radio base stations. That is, in the first embodiment, the anchor radio base station 310A and the non-anchor radio base stations 310B are one of the MeNB 110A, the HeNB 110B, the MNB 210A, and the HNB 210B.

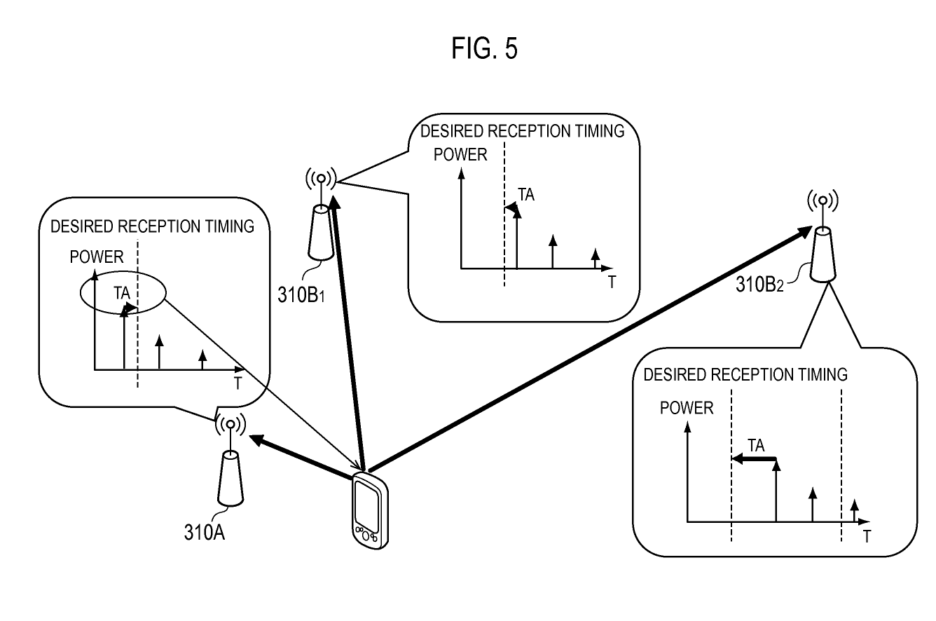

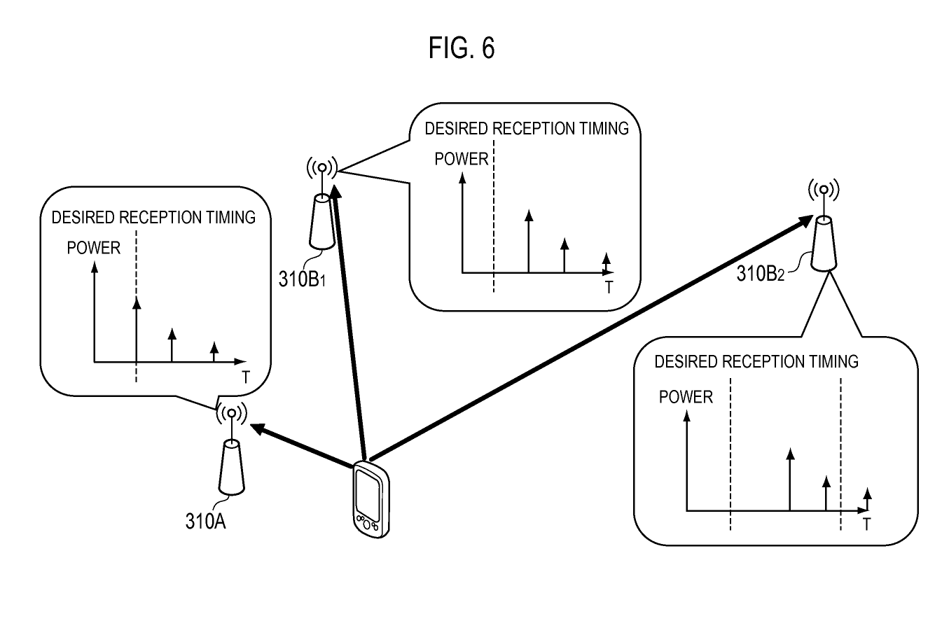

Furthermore, the case, in which a non-anchor radio base station 310B₁ and a non-anchor radio base station 310B₂ are provided as the non-anchor radio base stations 310B, will be described with reference to FIG. 5 and FIG. 6.

In such a case, a shift (that is, TA; Timing Advance) between a reception timing of an uplink signal received from the UE 10 and a desired reception timing differs in each radio base station as illustrated in FIG. 5.

In the first embodiment, the anchor radio base station 310A transmits the control signal (TA) for adjusting the timing, at which the UE 10 transmits the uplink signal, to the UE 10 in order to adjust the timing, at which the uplink signal is received from the UE 10, to a desired timing. In this way, as illustrated in FIG. 6, in the anchor radio base station 310A, the timing, at which the uplink signal is received from the UE 10, is adjusted to the desired timing.

Meanwhile, in the non-anchor radio base station 310B₁ and the non-anchor radio base station 310B₂, as illustrated in FIG. 6, the timing, at which the uplink signal is received from the UE 10, remains shifted from the desired timing. In such a case, the non-anchor radio base station 310B₁ and the non-anchor radio base station 310B₂ measure the reception quality of the uplink signal received from the UE 10. Then, the non-anchor radio base station 310B₁ and the non-anchor radio base station 310B₂ notify the anchor radio base station 310A of the measured reception quality.

On the basis of the reception quality notified from the non-anchor radio base station 310B₁ and the non-anchor radio base station 310B₂, the anchor radio base station 310A determines whether or not to exclude the non-anchor radio base station 310B from a radio base station group including radio base stations that perform a cooperative reception process in an uplink.

According to a first technique, the anchor radio base station 310A excludes a non-anchor radio base station 310B, which measures (notifies of) reception quality, from the radio base station group, wherein a difference between the reception quality measured (informed) by the non-anchor radio base station 310B and the best reception quality exceeds a first threshold value. The best reception quality indicates the highest reception quality between reception quality measured by the anchor radio base station 310A and reception qualities measured by the non-anchor radio base stations 310B.

According to a second technique, the anchor radio base station 310A excludes a non-anchor radio base station 310B, which measures (notifies of) reception quality that is less than a second threshold value, from the radio base station group.

In the first embodiment, the anchor radio base station 310A may exclude a non-anchor radio base station 310B, which satisfies both of the condition of the first technique and the condition of the second technique, from the radio base station group. Alternatively, the anchor radio base station 310A may exclude a non-anchor radio base station 310B, which satisfies one of the condition of the first technique and the condition of the second technique, from the radio base station group.

Furthermore, the reception quality, for example, includes SINR (Signal to Interference Ratio), C/I (Carrier to Interference), a reception level, and the like of the uplink signal transmitted from the UE 10. An uplink signal, the reception quality of which is to be measured includes, for example, DM RS (Demodulation Reference Signal) or SRS (Sounding Reference Signal). The DM RS is a reference signal that is used in the demodulation of PUSCH. The SRS is a reference signal that is distributed over an entire uplink band.

(Anchor Radio Base Station)

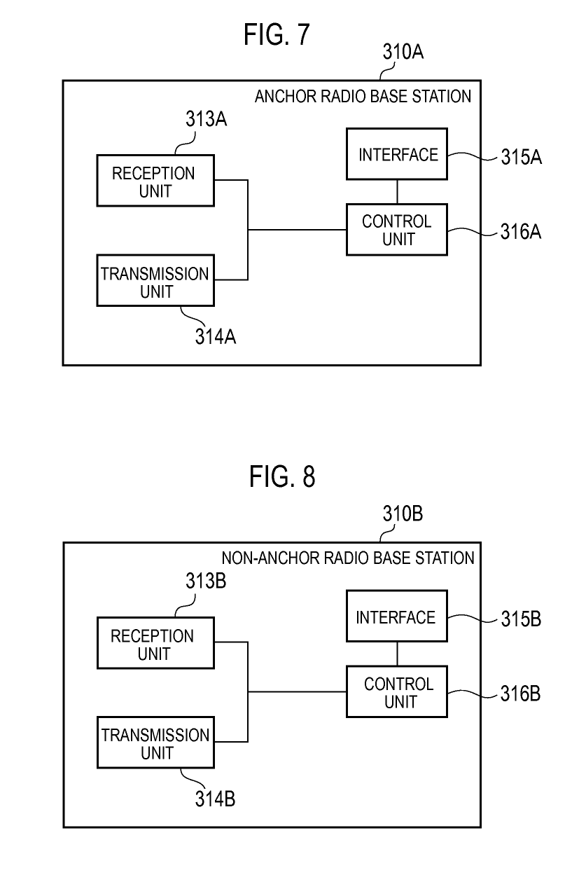

Hereinafter, an anchor radio base station according to the first embodiment will be described. FIG. 7 is a block diagram illustrating an anchor radio base station 310A according to the first embodiment.

As illustrated in FIG. 7, the anchor radio base station 310A includes a reception unit 313A, a transmission unit 314A, an interface 315A, and a control unit 316A.

The reception unit 313A is configured to receive an uplink signal from the UE 10 connected to a cell managed by the anchor radio base station 310A. The reception unit 313A, for example, receives the uplink signal through the uplink shared channel (PUSCH).

The transmission unit 314A is configured to transmit a downlink signal to the UE 10 connected to the cell managed by the anchor radio base station 310A. The transmission unit 314A constitutes a transmission unit configured to transmit the control signal (TA) for adjusting the timing, at which the UE 10 transmits the uplink signal, to the UE 10 in order to adjust the timing, at which the uplink signal is received from the UE 10, to a desired timing. The transmission unit 314A transmits a radio resource (scheduling information), which was assigned by the anchor radio base station 310A, to the UE 10 that uses the anchor radio base station 310A as a serving base station (a serving cell).

The interface 315A is an interface used for performing communication with another radio base station through the backhaul network. The interface 315A is an X2 interface for directly connecting radio base stations to each other. Alternatively, the interface 315A is an S1 interface for connecting the radio base stations to each other through an upper node (for example, the MME 130).

In the first embodiment, the interface 315A acquires reception quality (reception quality of an uplink signal received in the non-anchor radio base station 310B from the UE 10), which was measured by the non-anchor radio base station 310B, from the non-anchor radio base station 310B via the backhaul network. The interface 315A receives an uplink signal (PUSCH), which is received in the non-anchor radio base station 310B, from the non-anchor radio base station 310B via the backhaul network.

The control unit 316A is configured to control the operation of the anchor radio base station 310A. For example, the control unit 316A performs selection combining of an uplink signal (PUSCH) received from the UE 10 and an uplink signal (PUSCH) received from the non-anchor radio base station 310B.

In the first embodiment, on the basis of the reception quality notified from the non-anchor radio base station 310B, the control unit 316A determines whether or not to exclude the non-anchor radio base station 310B from the radio base station group including radio base stations that perform the cooperative reception process in the uplink.

According to the first technique, the control unit 316A excludes a non-anchor radio base station 310B, which measures (notifies of) reception quality, from the radio base station group, wherein the difference between the reception quality measured (informed) by non-anchor radio base station 310B and the best reception quality exceeds the first threshold value. In the first technique, the control unit 316A constitutes an anchor side measurement unit configured to measure the reception quality of the uplink signal received from the UE 10.

In addition, as described above, the best reception quality indicates the highest reception quality between the reception quality measured by the anchor radio base station 310A and the reception qualities measured by the non-anchor radio base stations 310B.

According to the second technique, the control unit 316A excludes a non-anchor radio base station 310B, which measures (notifies of) the reception quality that is less than the second threshold value, from the radio base station group.

As described above, the reception quality includes, for example, SINR (Signal to Interference Ratio), C/I (Carrier to Interference), and a reception level of the uplink signal transmitted from the UE 10. An uplink signal, the reception quality of which is to be measured includes, for example, DM RS (Demodulation Reference Signal) or SRS (Sounding Reference Signal). The DM RS is a reference signal that is used in the demodulation of PUSCH. The SRS is a reference signal that is distributed over an entire uplink band.

(Non-Anchor Radio Base Station)

Hereinafter, a non-anchor radio base station according to the first embodiment will be described. FIG. 8 is a block diagram illustrating a non-anchor radio base station 310B according to the first embodiment.

As illustrated in FIG. 8, the non-anchor radio base station 310B includes a reception unit 313B, a transmission unit 314B, an interface 315B, and a control unit 316B.

The reception unit 313B is configured to receive an uplink signal from the UE 10 connected to a cell managed by the non-anchor radio base station 310B. The reception unit 313B, for example, receives the uplink signal through the uplink shared channel (PUSCH).

The transmission unit 314B is configured to transmit a downlink signal to the UE 10 connected to the cell managed by the non-anchor radio base station 310B. The transmission unit 314B transmits a radio resource (scheduling information), which was assigned by the non-anchor radio base station 310B, to the UE 10 that uses the non-anchor radio base station 310B as a serving base station (a serving cell).

The interface 315B is an interface for performing communication with another radio base station through the backhaul network. The interface 315B is an X2 interface for directly connecting radio base stations to each other. Alternatively, the interface 315B is an S1 interface for connecting the radio base stations to each other through an upper node (for example, the MME 130).

In the first embodiment, the interface 315B notifies the anchor radio base station 310A of the reception quality (the reception quality of the uplink signal received in the non-anchor radio base station 310B from the UE 10), which was measured by the non-anchor radio base station 310B, via the backhaul network. The interface 315B transmits an uplink signal (PUSCH), which is received in the non-anchor radio base station 310B, to the anchor radio base station 310A via the backhaul network.

The control unit 316B is configured to control the operation of the non-anchor radio base station 310B. In the first embodiment, the control unit 316B constitutes a non-anchor side measurement unit configured to measure the reception quality of the uplink signal received from the UE 10.

As described above, the reception quality includes, for example, SINR (Signal to Interference Ratio), C/I (Carrier to Interference), and a reception level of the uplink signal transmitted from the UE 10. An uplink signal, the reception quality of which is to be measured includes, for example, DM RS (Demodulation Reference Signal) or SRS (Sounding Reference Signal). The DM RS is a reference signal that is used in the demodulation of PUSCH. The SRS is a reference signal that is distributed over an entire uplink band.

(Operation of Mobile Communication System)

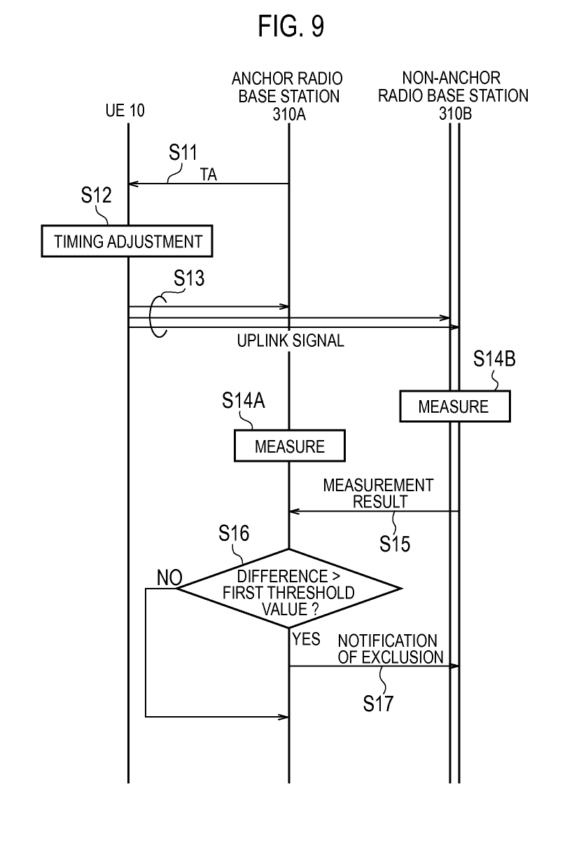

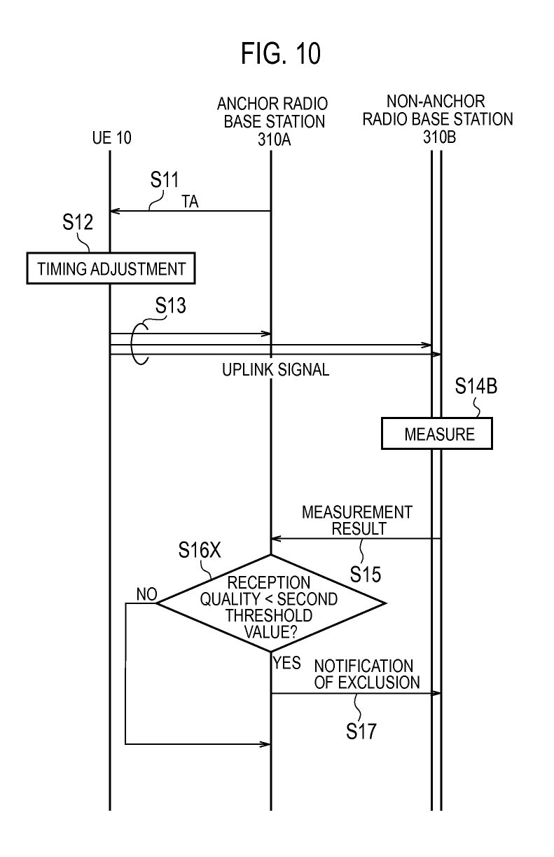

Hereinafter, the operation of the mobile communication system according to the first embodiment will be described. FIG. 9 and FIG. 10 are sequence diagrams illustrating the operation of the mobile communication system 100 according to the first embodiment.

Firstly, the first technique, in which the non-anchor radio base station 310B, which measures (notifies of) the reception quality, is excluded from the radio base station group, will be described with reference to FIG. 9, wherein the difference between the reception quality measured by the non-anchor radio base station 310B and the best reception quality exceeds the first threshold value.

As illustrated in FIG. 9, in step 11, the anchor radio base station 310A transmits the control signal (TA) for adjusting the timing, at which the UE 10 transmits the uplink signal, to the UE 10 in order to adjust the timing, at which the uplink signal is received from the UE 10, to a desired timing.

In step 12, on the basis of the control signal (TA) received from the anchor radio base station 310A, the UE 10 adjusts the transmission timing of the uplink signal.

In step 13, the UE 10 transmits an uplink signal (PUSCH) at the timing adjusted in step 12. Furthermore, the anchor radio base station 310A and the non-anchor radio base station 310B perform the cooperative reception process in the uplink.

In step 14A, the anchor radio base station 310A measures the reception quality of the uplink signal (for example, “DM RS” or “SRS”) received from the UE 10. In the same manner, in step 14B, the non-anchor radio base station 310B measures the reception quality of the uplink signal (for example, “DM RS” or “SRS”) received from the UE 10.

In step 15, the non-anchor radio base station 310B notifies the anchor radio base station 310A of the reception quality (the reception quality of the uplink signal received in the non-anchor radio base station 310B from the UE 10) measured by the non-anchor radio base station 310B via the backhaul network.

In step 16, the anchor radio base station 310A determines whether or not the difference between the best reception quality and the reception quality notified from the non-anchor radio base station 310B is larger than the first threshold value. In addition, as described above, the best reception quality indicates the highest reception quality between the reception quality measured by the anchor radio base station 310A and the reception qualities measured by the non-anchor radio base stations 310B.

When a determination result is “YES”, the anchor radio base station 310A proceeds to a process of step 17. When a determination result is “NO”, the anchor radio base station 310A ends a series of processes.

In step 17, the anchor radio base station 310A notifies the non-anchor radio base station 310B, which measures (notifies of) reception quality, of the fact that the non-anchor radio base station 310B is excluded from the radio base station group, wherein the difference between the reception quality measured (informed) by the non-anchor radio base station 310B and the best reception quality exceeds the first threshold value.

Secondly, the second technique, in which the non-anchor radio base station 310B, which measures (notifies of) the reception quality that is less than the second threshold value, is excluded from the radio base station group, will be described with reference to FIG. 10. In FIG. 10, the same reference numerals are used to designate the same processes as those of FIG. 9. Accordingly, a description of the same processes as those of FIG. 9 will be omitted.

As compared with the flow illustrated in FIG. 9, in the flow illustrated in FIG. 10, the process of step 14A is omitted. Furthermore, instead of the process of step 16, a process of step 16X is performed.

In step 16X, the anchor radio base station 310A determines whether or not the reception quality notified from the non-anchor radio base station 310B is less than the second threshold value.

When a determination result is “YES”, the anchor radio base station 310A proceeds to a process of step 17. That is, in step 17, the anchor radio base station 310A notifies the non-anchor radio base station 310B, which measures (notifies of) the reception quality being less than the second threshold value, of the fact that the non-anchor radio base station 310B is excluded from the radio base station group. When a determination result is “NO”, the anchor radio base station 310A ends a series of processes.

In the second technique, the anchor radio base station 310A determines whether or not the reception quality notified from the non-anchor radio base station 310B is less than the second threshold value. However, the second technique is not limited thereto. Specifically, the non-anchor radio base station 310B may determine whether or not the reception quality of an uplink signal received in the non-anchor radio base station 310B from the UE 10 is less than the second threshold value. When the reception quality is less than the second threshold value, the non-anchor radio base station 310B notifies the anchor radio base station 310A of the fact that the reception quality is less than the second threshold value.

In FIG. 9 and FIG. 10, the first technique and the second technique are separately described. However, the embodiment is not limited thereto. For example, the anchor radio base station 310A may exclude a non-anchor radio base station 310B, which satisfies both of the condition of the first technique and the condition of the second technique, from the radio base station group. Alternatively, the anchor radio base station 310A may exclude a non-anchor radio base station 310B, which satisfies one of the condition of the first technique and the condition of the second technique, from the radio base station group.

(Operation and Effect)

In the first embodiment, the timing, at which the uplink signal is received from the UE 10, is adjusted to a desired timing for the anchor radio base station 310A, and then whether or not the non-anchor radio base station 310B is excluded from the radio base station group is determined on the basis of the reception quality notified from the non-anchor radio base station 310B. Consequently, it is possible to appropriately exclude a radio base station (a non-anchor radio base station 310B), which does not contribute to the cooperative reception process in the uplink, from the radio base station group.

Moreover, since it is not necessary to transmit an uplink signal from the radio base station (the non-anchor radio base station 310B), which does not contribute to the cooperative reception process in the uplink, to the anchor radio base station 310A via the backhaul network, wasteful consumption of a resource of the backhaul network is suppressed.

[First Modification]

Hereafter, a first modification of the first embodiment is explained. Mainly differences from the first embodiment are described below.

Particularly not mentioned in the first embodiment, in the first modification, the first threshold value is variable. Specifically, as a technique for setting the first threshold value, a first technique and a second technique will be described.

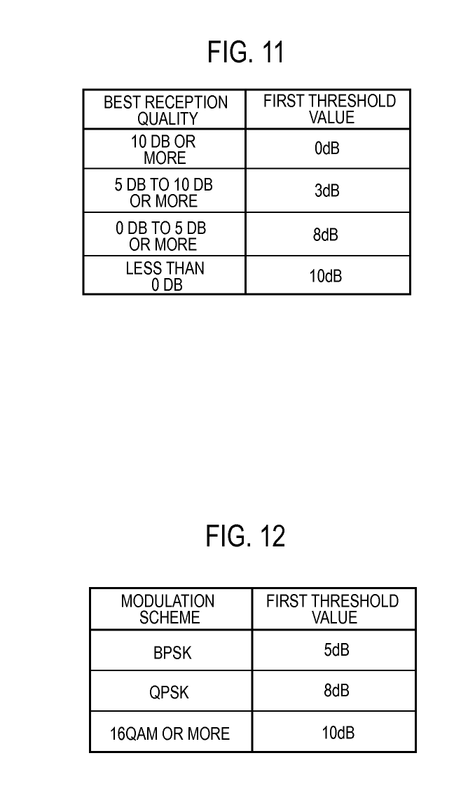

In the first technique, as illustrated in FIG. 11, the first threshold value is decided in response to the best reception quality. Specifically, as the best reception quality is better, a smaller value is employed as the first threshold value. That is, when the reception quality of the uplink signal (PUSCH) is good, a small value is employed as the first threshold value.

For example, when the best reception quality (SINR) is equal to or more than 10 dB, 0 dB is employed as the first threshold value. That is, the fact that the first threshold value is 0 dB represents that the cooperative reception process in the uplink is not performed. Meanwhile, when the best reception quality (SINR) is smaller than 0 dB, 10 dB is employed as the first threshold value. That is, the first threshold value is decided such that many non-anchor radio base stations 310B are included in the radio base station group.

In the second technique, as illustrated in FIG. 12, the first threshold value is decided in response to a modulation scheme of the uplink signal (PUSCH). Specifically, as an order of the modulation scheme is lower, a smaller value is employed as the first threshold value. That is, when the reception quality of the uplink signal (PUSCH) is assumed to be good, a small value is employed as the first threshold value.

For example, when the modulation scheme is BPSK, 5 dB is employed as the first threshold value. Meanwhile, when the modulation scheme is equal to or more than 16QAM, 10 dB is employed as the first threshold value.

The first threshold value may be decided by a combination of the first technique and the second technique. In such a case, as the best reception quality is better and the order of the modulation scheme is low, a smaller value is employed as the first threshold value.

### Other Embodiments

The present invention is explained through the above embodiment, but it must not be understood that this invention is limited by the statements and the drawings constituting a part of this disclosure. From this disclosure, various alternative embodiments, examples, and operational technologies will become apparent to those skilled in the art.

Particularly not mentioned in the embodiment, the anchor radio base station 310A is generally a serving base station (a serving cell) for the UE 10 that is an object of the cooperative reception process in the uplink. Furthermore, since the timing, at which the uplink signal is received from the UE 10, is adjusted to a desired timing, the best reception quality is generally reception quality that is measured in the anchor radio base station 310A.

Particularly not mentioned in the aforementioned embodiment, a program, which causes a computer to perform each process performed by the UE 10, the anchor radio base station 310A, and the non-anchor radio base station 310B, may be provided. Furthermore, the program may be recorded on a computer-readable medium. By using the computer-readable medium, it is possible to install the program in a computer. Furthermore, the computer-readable medium recording the program thereon may include a non-transitory recording medium. The non-transitory recording medium is not particularly limited. For example, the non-transitory recording medium may include a recording medium such as a CD-ROM or a DVD-ROM.

Alternatively, a chip, which includes a memory for storing the program for performing each process performed by the UE 10, and a processor for executing the program stored in the memory, may be provided.

In the aforementioned embodiment has described an example in which the present invention is applied to the LTE system. However, the present invention may also be applied to systems, other than the LTE system, as well as the LTE system.

In addition, the entire content of U.S. Provisional Application No. 61/724,393 (filed on Nov. 9, 2012) is incorporated in the present specification by reference.

### INDUSTRIAL APPLICABILITY

As described above, the mobile communication system and the mobile communication method according to the present invention are capable of appropriately excluding a radio base station, which does not contribute to a cooperative reception process in an uplink, from the radio base station group, and thus they are useful in a mobile communication filed.

1. A mobile communication system, which includes a plurality of radio base stations that communicate with a radio terminal, wherein
the plurality of radio base stations constitute a radio base station group including one anchor radio base station and non-anchor radio base stations other than the anchor radio base station,
the non-anchor radio base station comprises:
a non-anchor side measurement unit configured to measure reception quality of an uplink signal received from the radio terminal; and
a notification unit configured to notify the anchor radio base station of the reception quality measured by the non-anchor side measurement unit, and
the anchor radio base station comprises:
a transmission unit configured to transmit a control signal for adjusting a timing, at which the radio terminal transmits an uplink signal, to the radio terminal in order to adjust a timing, at which an uplink signal is received from the radio terminal, to a desired timing; and
a determination unit configured to determine whether or not to exclude the non-anchor radio base station from the radio base station group on the basis of the reception quality notified from the non-anchor radio base station.

2. The mobile communication system according to claim 1, wherein
the anchor radio base station comprises: an anchor side measurement unit configured to measure the reception quality of the uplink signal received from the radio terminal, and
the determination unit determines to exclude a non-anchor radio base station that measures reception quality, from the radio base station group, wherein a difference between the reception quality measured by the non-anchor radio base station and best reception quality, which is included in the reception quality measured in the anchor side measurement unit and the reception quality measured in the non-anchor side measurement unit, exceeds a first threshold value.

3. The mobile communication system according to claim 1, wherein
the determination unit determines to exclude a non-anchor radio base station that measures reception quality that is measured by the non-anchor side measurement unit and that is less than a second threshold value, from the radio base station group.

4. The mobile communication system according to claim 2, wherein
the first threshold value is decided in response to the best reception quality.

5. The mobile communication system according to claim 2, wherein
the first threshold value is decided in response to a modulation scheme of the uplink signal.

6. A mobile communication method, which is used in a mobile communication system including a plurality of radio base stations that communicate with a radio terminal,
the plurality of radio base stations constituting a radio base station group including one anchor radio base station and non-anchor radio base stations other than the anchor radio base station, and the method comprising:
a step A of transmitting, by the anchor radio base station, a control signal for adjusting a timing, at which the radio terminal transmits an uplink signal, to the radio terminal, in order to adjust a timing, at which the uplink signal is received from the radio terminal, to a desired timing,
a step B of measuring, by the non-anchor radio base station, reception quality of an uplink signal received from the radio terminal,
a step C of notifying, by the non-anchor radio base station, the anchor radio base station of the reception quality measured in the step B, and
a step D of determining, by the anchor radio base station, whether or not to exclude the non-anchor radio base station from the radio base station group on the basis of the reception quality notified from the non-anchor radio base station.

7. An anchor radio base station of a radio base station group including the anchor radio base station and non-anchor radio base station, comprising:
a transmission unit configured to transmit a control signal for adjusting a timing, at which a radio terminal transmits the uplink signal, to the radio terminal,
a reception unit configured to receive, from the non-anchor radio base station, reception quality of an uplink signal from the radio terminal, the reception quality being measured by the non-anchor radio base station, and
a control unit configured to determine whether or not to exclude the non-anchor radio base station from the radio base station group on the basis of the reception quality.
